(19) United States
(12) Patent Application Publication
(10) Pub. No.: US 2008/0272621 A1
(43) Pub. Date: Nov. 6, 2008

(54) Door shock absorber

(75) Inventor: Martin Racine, Charlesbourg (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: 177197 CANADA LTEE

(21) Appl. No.: 11/882,262

(22) Filed: Jul. 31, 2007

(30) Foreign Application Priority Data
May 3, 2007 (CA) 2,587,286

(51) Int. Cl. E05F 5/02

(52) U.S. Cl. 296/207; 16/86 R

(57) ABSTRACT

A door shock absorber is disclosed. The door shock absorber is to be typically used with dump bodies with doors that frequently enter into contact with the rear external structure of the dump body. The shock absorber comprises a spring and an actuator supporting the spring for absorption of any impact between the door and the rear dump body structure or any other type of base structure. The spring retractably traverses a casing between a deployed position and a retracted position. The actuator actuates the spring between the deployed position, the retracted position, and at least one intermediate position between the deployed position and the retracted position.

This application claims the benefit of Canadian patent application CA 2,587,286 filed on May 3, 2007 the entire disclosure of which is incorporated herein by reference.

### FIELD OF THE INVENTION

The present invention generally relates to a shock absorber for doors. More particularly, the invention relates to a door shock absorber for doors entering into contact with a base structure.

### BACKGROUND OF THE INVENTION

Trucks having dump bodies, during the unloading process, produce large banging sounds as material are being unloaded from the truck and the truck moves in a jagged manner in order to shake out any materials from the dump body. The weight of the door and the shaking movement of the truck produce a very loud noise when the door enters into contact with the structure of the dump body. In residential areas, this noise can become a nuisance for the residents because its amplitude is significant and can even surprise individuals who are not expecting such a sound even if they are very far from the truck and the source of the banging noise. This has led to a significant number of complaints from residents towards their municipalities. In order to solve this noise problem, certain cities have attempted to install on the rear of the dump bodies a piece of rubber that could absorb a part of the energy of the closing door in order to decrease the noise being generated. However, this solution is not entirely satisfactory even though it might have reduced somewhat the number of complaints from certain residents with regards to this noise.

JP 2001-010394 by Takeuchi discloses a door shock absorber system for truck dump bodies. The system uses a piston mechanism to absorb the shock of any contact between the dump body and the door as materials are being unloaded from the truck. The piston mechanism occupies a substantial amount space around the truck body.

EP 1,305,539 by WILLNER describes a shock absorption system comprising a plate supported by a magnet. The component that absorbs the shock in this system can be placed in two different positions through rotation of the component with respect to the magnet. This system does not provide means for adjusting the component without having recourse to a relative rotational movement.

U.S. Pat. No. 6,039,388 by CHOI describes a shock absorption system between a car hood and body. The system comprises an elastic element on the hood and a second elastic element on the car body supported by a spring-element. Any contact between the hood and the body is absorbed by the contact between the two elastic elements and the spring-element. The spring element can be mechanical, pneumatic or hydraulic. CHOI does not describe means to put the elastic elements in a retracted position for closing of the hood.

Therefore, there is presently a need for a new door shock absorption system that improves the noise reduction associated with any banging of the door against a dump body or any base structure, while providing a retracted position for allowing proper closing of the door against the structure.

### SUMMARY OF THE INVENTION

An object of the present invention is to propose a door shock absorber that is to be used on the interface between a door and a dump body structure on a truck or any other base structure.

According to the present invention, there is provided a door shock absorber for use between a base structure and a door, comprising:
a casing;
a spring retractably traversing the casing between a deployed position and a retracted position; and
an actuator housed within the casing for actuation of the spring between the deployed position, the retracted position, and at least one intermediate position between the deployed position and the retracted position,
   wherein the spring absorbs an impact between the door and the structure when the spring is placed in the deployed position.

As the door hits a dump body, for example, the door first hits the spring, preferably a rubber spring, which is fixed on and positioned by the actuator, which is preferably a pneumatic balloon. Consequently, the energy of the closing door is absorbed by the rubber springs and the pneumatic balloons, which has the effect of making the door bounce against the dump body instead of making it collide directly on the steel structure. This decreases significantly the noise associated with the contact between the door and the dump body.

A non-restrictive description of a preferred embodiment of the invention will now be given with reference to the appended drawings.

### BRIEF DESCRIPTION OF THE DRAWINGS

FIG. 1 is a top view of the shock absorber in a rest position according to a preferred embodiment of the present invention;

FIG. 2 is a side cross sectional view of the shock absorber shown in FIG. 1;

FIG. 3 is a top view of the shock absorber shown in work, absorbing a contact between a door and a dump body structure in accordance with a preferred embodiment of the present invention; and

FIG. 4 is a side cross sectional view of the shock absorber shown in FIG. 3.

### DESCRIPTION OF PREFERRED EMBODIMENTS OF THE INVENTION

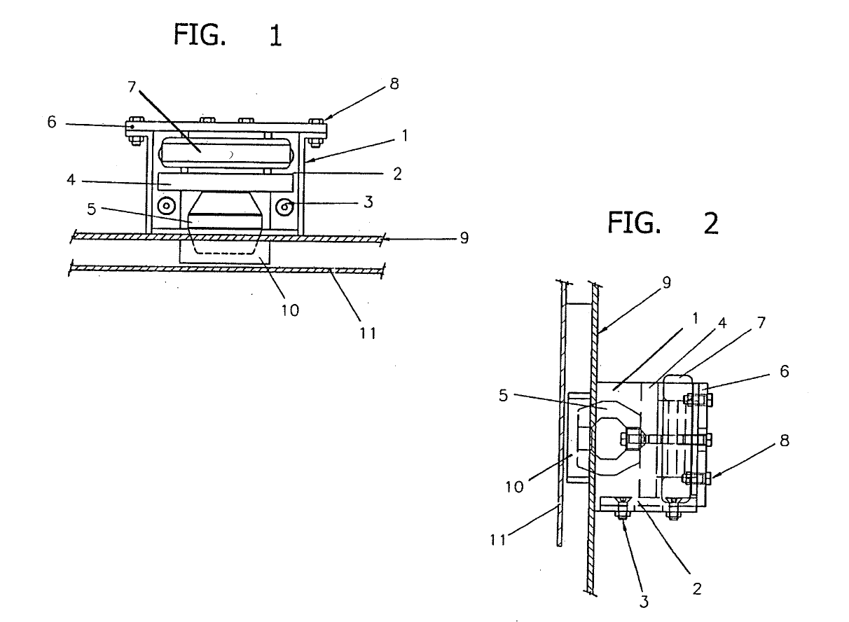

FIGS. 1 to 4 illustrate a preferred embodiment of the invention. As shown in FIGS. 1 to 4, the shock absorber according to the present invention comprises a rubber spring and a pneumatic balloon supporting the rubber spring.

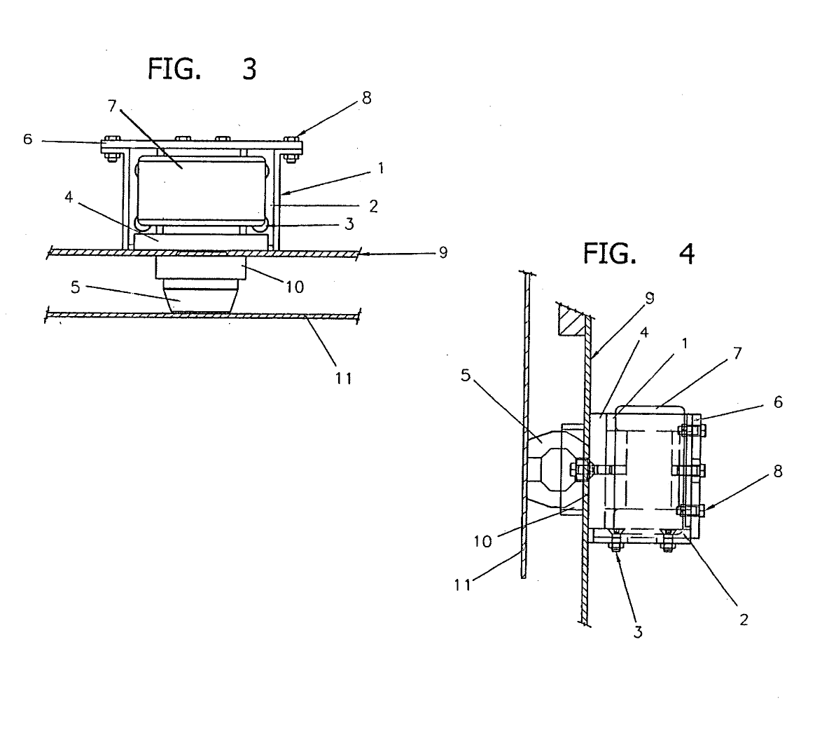

More particularly, the present invention provides a door shock absorber for use between a base structure 9 and a door 11. The door shock absorber comprises a spring 5, preferably a rubber spring or a hollow rubber spring, retractably traversing the base structure 9 between a deployed position (shown in FIGS. 3 and 4) and a retracted position (shown in FIGS. 1 and 2). The shock absorber further comprises an actuator, preferably a pneumatic balloon 7, for actuation of the rubber spring 5 between the deployed position and the retracted position. The shock absorber also comprises a casing 1 fixed on the base structure 9 and housing the rubber spring 5 and the pneumatic balloon 7. As shown in FIGS. 3 and 4, the rubber spring 5 absorbs an impact between the door 11 and the base structure 9 when the rubber spring 5 is placed in the deployed position. The actuator can selectively place the spring in a number of positions between the retracted and deployed positions if required. In alternate embodiments, the shock absorber may be placed on the door or any other position to permit deployment of the spring between the door and the base structure.

Preferably, in dump body truck applications, the shock absorber is located within a casing 1 fixed on the inside base structure 9 of the dump body. In this configuration, the actuator further comprises an actuator support plate fixed on the casing, and the base structure comprises an opening through which the spring passes. Preferably, the shock absorber comprises a spring support plate 4 connecting the spring to the actuator and the opening of the base structure is sized to allow passage of the spring and to block passage of the spring support plate 4. Hence, the interior structure of the dump body plays the role of a stop structure for the support plate 4 of an Aeon™ rubber spring 5. Preferably, a non-stick plate 2 is fixed on the casing and the spring support plate is in slideable contact with a surface of the non-stick plate. Preferably, the surface of the non-stick plate is made of polytetrafluoroethylene. As shown in FIGS. 1 and 2, to ensure good sliding movement of the mechanism, a Teflon™ plate 2, for example, is fixed into place with flat head screws 3. The casing 1 also places the role of a support structure for the pneumatic balloon 7. The pneumatic balloon 7 support plate 6 is fixed on the casing 1 with a fastener, such as a bolt 8 in order to allow the rubber spring 5 to traverse the rear structure of the dump body. The shock absorber further comprises a round tube 10 having a diameter slightly greater than the rubber spring 5 and acts as a guide for movement of the spring 5 towards the back door panel 11 when it is being deployed. In order to allow complete closing of the back door panel 11 against the base structure 9, and in order to insure proper sealing between the door and the dump body structure, the rubber spring may be placed in a retracted position as shown in FIGS. 1 and 2. In this retracted position, the rubber spring does not touch the rear door panel, and therefore does not interfere with any locking or retention system between the door and the dump body.

As shown in FIG. 3, when the rear door panel locking or retention system is unlocked, the pneumatic balloons 7 are inflated. The rubber spring 5 support plate 4 slides on the Teflon™ plates 2. The pneumatic balloon then rests against the internal base structure 9 of the dump body and therefore pushes the rubber spring 5 beyond the round tube 10 in order to prevent any contact between the rear door panel 11 against the structure of the dump body base structure 9 as shown in FIG. 4. As direct contact between the rear door panel and the dump body structure is avoided, there is a significant reduction in the amount of decibels associated with the noise due to banging of the door against the dump body structure.

This shock absorber system could easily be adapted to several other types of doors that possibly hit against fixed structure, as long as some form of actuation means is provided in order to move the spring between a deployed and retracted position. The actuation means can be a pneumatic balloon, a mechanical device actuated manually or any other type of similar actuation mechanism. Preferably, the actuator is selected from the group consisting of a pneumatic balloon, a manual mechanical actuator, an electromechanical actuator, an electro-static actuator, a piezo-electric actuator, a thermo-mechanical actuator, an electromagnetic actuator, and a polymer actuator.

As mentioned above, in alternate embodiments, the shock absorber may be placed either on the base structure, or the door or any other position to permit deployment of the spring between the door and the base structure for absorption of the contact between the door and the base structure.

Although the present invention has been explained hereinabove by a way of a preferred embodiment thereof, it should be understood that the invention is not limited to this precise embodiment and that various changes and modifications may be effected therein without departing from the scope or spirit of the invention.

1. A door shock absorber for use between a base structure and a door, comprising:
a casing;
a spring retractably traversing the casing between a deployed position and a retracted position; and
an actuator housed within the casing for actuation of the spring between the deployed position, the retracted position, and at least one intermediate position between the deployed position and the retracted position,
wherein the spring absorbs an impact between the door and the structure when the spring is placed in the deployed position.

2. The door shock absorber according to claim 1, wherein the actuator is selected from the group consisting of a pneumatic balloon, a manual mechanical actuator, an electromechanical actuator, an electrostatic actuator, a piezo-electric actuator, a thermo-mechanical actuator, an electromagnetic actuator, and a polymer actuator.

3. The door shock absorber according to claim 1, wherein the spring is a rubber spring.

4. The door shock absorber according to claim 1, wherein the spring is a hollow rubber spring.

5. The door shock absorber according to claim 1, wherein the casing is fixed on the base structure, the actuator further comprises an actuator support plate fixed on the casing, and the base structure comprises an opening through which the spring passes.

6. The door shock absorber according to claim 1, wherein the casing is fixed on the door, the actuator further comprises an actuator support plate fixed on the casing, and the door comprises an opening through which the spring passes.

7. The door shock absorber according to claim 1, further comprising a spring support plate connecting the spring to the actuator.

8. The door shock absorber according to claim 5, further comprising a spring support plate connecting the spring to the actuator and wherein the opening of the base structure is sized to allow passage of the spring and to block passage of the spring support plate.

9. The door shock absorber according to claim 6, further comprising a spring support plate connecting the spring to the actuator and wherein the opening of the door is sized to allow passage of the spring and to block passage of the spring support plate.

10. The door shock absorber according to claim 7, further comprising a non-stick plate fixed on the casing and the spring support plate is in slideable contact with a surface of the non-stick plate.

11. The door shock absorber according to claim 10, wherein the surface of the non-stick plate is made of polytetrafluoroethylene.

12. The door shock absorber according to claim 1, further comprising a tube surrounding the spring and extending away from the casing in a direction of travel of the spring.

13. A dump body of a truck comprising a door shock absorber as defined in claim 1.

14. The door shock absorber according to claim 2, wherein the spring is a hollow rubber spring.

15. The door shock absorber according to claim 14, wherein the casing is fixed on the base structure, the actuator further comprises an actuator support plate fixed on the casing, and the base structure comprises an opening through which the spring passes.

16. The door shock absorber according to claim 15, further comprising a spring support plate connecting the spring to the actuator.

17. The door shock absorber according to claim 16, further comprising a spring support plate connecting the spring to the actuator and wherein the opening of the base structure is sized to allow passage of the spring and to block passage of the spring support plate.

18. The door shock absorber according to claim 17, further comprising a non-stick plate fixed on the casing and the spring support plate is in slideable contact with a surface of the non-stick plate.

19. The door shock absorber according to claim 18, further comprising a tube surrounding the spring and extending away from the casing in a direction of travel of the spring.

20. A dump body of a truck comprising a door shock absorber as defined in claim 19.
